(19) United States
(12) Patent Application Publication
(10) Pub. No.: US 2013/0220851 A1
(43) Pub. Date: Aug. 29, 2013

(54) CONTACT LENS CASE WITH REMOVABLE GRIPPERS AND METHODS

(71) Applicants: Robert N. Priebe, Bloomington, MN (US); Eric Bombardt, Inver Grove Heights, MN (US)

(72) Inventors: Robert N. Priebe, Bloomington, MN (US); Eric Bombardt, Inver Grove Heights, MN (US)

(21) Appl. No.: 13/408,545

(22) Filed: Feb. 29, 2012

(51) Int. Cl. B67B 7/00; B23P 11/00; A45C 11/00

(52) U.S. Cl. 206/234; 206/38; 81/3.4; 29/428

(57) ABSTRACT

A contact lens case assembly includes a base and at least a first lid. At least a first removeable and replaceable gripping ring having a band is against and circumscribing the surrounding wall of the first lid.

### TECHNICAL FIELD

This disclosure relates to contact lens cases. Specifically, this disclosure relates to contact lens cases having removable and replaceable grippers, kits for such use, and methods of use.

### BACKGROUND

Contact lens cases are made to hold and store contact lenses. Generally, contact lens cases include a base with wells for left and right lenses. The wells are covered by removable lids that are often connected to the base case with a threaded connection. Improvements in contact lens cases are desired to allow for easier operator use and also to allow for customization in appearance.

### SUMMARY

The present disclosure provides a contact lens case assembly that allows for easier operator use, and also that allows for customization in the appearance of the lens case.

In one aspect, a contact lens case assembly is provided including a base having at least have a first well sized to accommodate a contact lens, and at least a first lid removably connected to selectively cover and expose the first well. The first lid has a surrounding wall and a closed top. At least a first removable and replaceable gripping ring having a band is against and circumscribing the surrounding wall of the first lid.

In another aspect, a gripping ring is provided. The gripping ring is for removable placement on a lid of a contact lens case. The gripping ring includes a band having first and second opposite ends, with the first end being a free end. The band has an inner radial surface and an opposite outer radial surface. An axial face is perpendicular to the second end. The axial face extends radially inwardly from the second end of the band and defines an opening therein. A plurality of circumferentially spaced projections on the inner radial surface extends at least partially between the first and second opposite ends.

In another aspect, a method of using a contact lens case is provided. The method includes a step of providing a contact lens case having a base with at least a first well sized to accommodate a contact lens and at least a first lid removably connected to cover the first well. The first lid has a surrounding wall and a closed top. The method further includes a step of removably attaching a first gripping ring having a band against and around the surrounding wall of the first lid.

In another aspect, a kit is provided. The kit includes a contact lens case, including a base having at least first and second wells each sized to accommodate a contact lens, and at least first and second lids removably connected to selectively cover and expose the first and second wells. The kit also includes a plurality of elastomeric gripping rings, each of the gripping rings being constructed and arranged to removably attach against and around an individual one of the first lid and second lid.

A variety of examples of desirable product features or methods are set forth, in part, in the description that follows, and in part, will be apparent from the description, or maybe learned by practice in various aspects of the disclosure. The aspects of the disclosure may relate to individual features as well as combinations of features. It should be understood that both the foregoing general description and the following detailed description are explanatory only, and are not restrictive of the claimed invention.

There is no specific requirement that the components, features, or assemblies include all of the features depicted and techniques disclosed in order to obtain some advantage. In general, selected use of the features or methods, without the use of others, can still lead to advantageous systems.

### BRIEF DESCRIPTION OF THE DRAWINGS

FIG. 1 is a perspective view of one embodiment of a contact lens case assembly, constructed in accordance with principles of this disclosure;

FIG. 2 is an exploded, perspective view of the contact lens case assembly of FIG. 1;

FIG. 3 is another exploded, perspective view of the contact lens case assembly of FIG. 1;

FIG. 4 is a front view of the contact lens case assembly of FIG. 1;

FIG. 5 is a cross-sectional view of the contact lens case assembly of FIG. 1, the cross-section being taken along the line 5-5 of FIG. 6;

FIG. 6 is a top view of the contact lens case assembly of FIG. 1; and

FIG. 7 is a cross-sectional view of the contact lens case assembly of FIG. 1, the cross-section being taken along the line 7-7 of FIG. 6.

### DETAILED DESCRIPTION

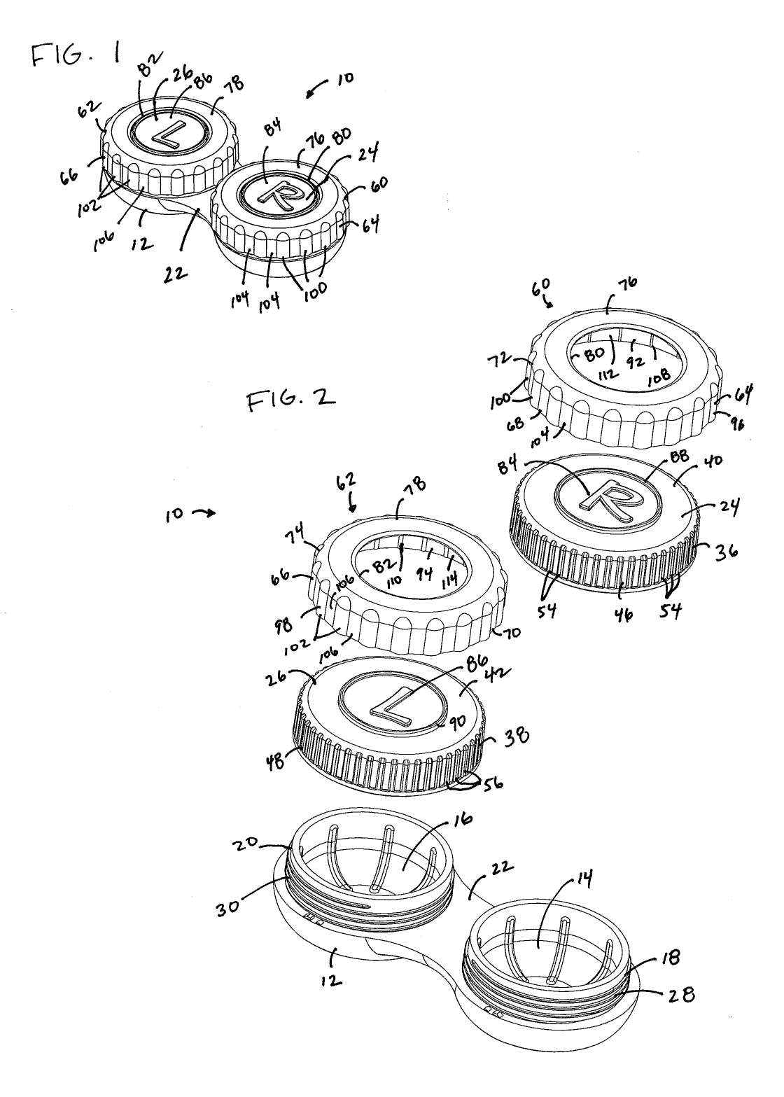

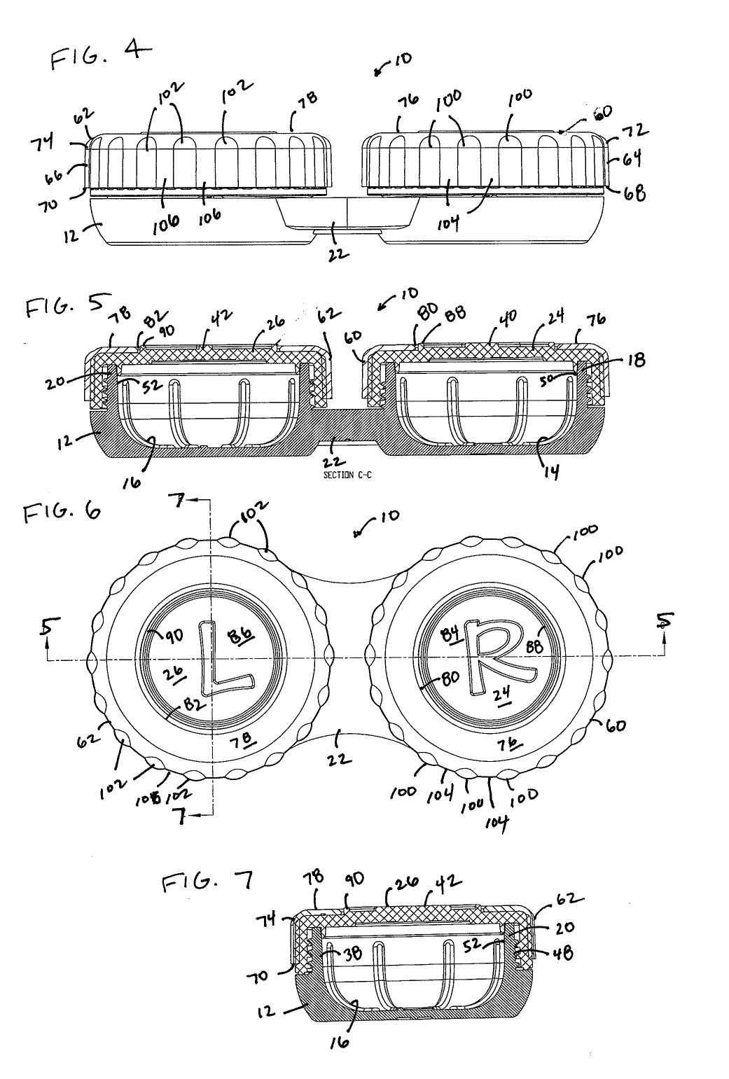

A contact lens case assembly is shown in FIGS. 1-7 at reference numeral 10. In general, the assembly 10 includes a base 12. The base 12 has at least a first well 14 sized to accommodate a contact lens. In the embodiment shown, the base 12 also includes a second well 16, also sized to accommodate a contact lens.

The first and second wells 14, 16 each includes a cylindrical wall 18, 20 circumscribing or surrounding the wells 14, 16. The wells 14, 16 are connected by a bridge region 22.

The assembly 10 further includes a first lid 24. The first lid 24 is removably connectable to selectively cover and expose one of the first and second wells 14, 16. In the embodiment shown, the assembly 10 also includes a second lid 26. The second lid 26 is removably connectable to selectively cover and expose one of the first and second wells 14, 16.

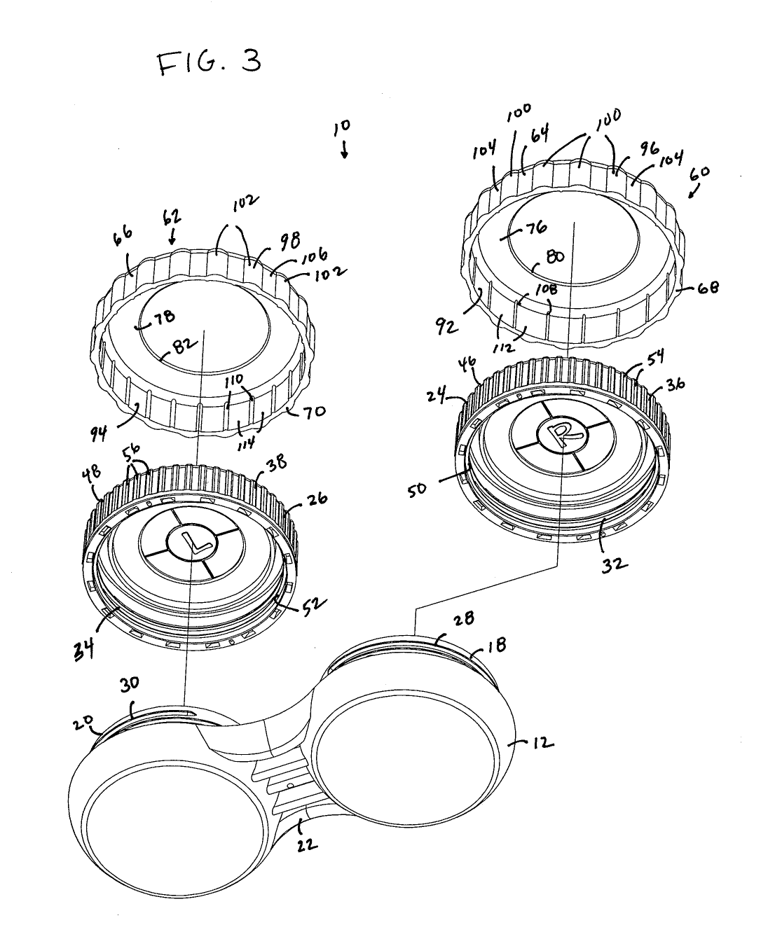

A variety of ways of attaching the lids 24, 26 to cover the wells 14, 16 are possible. In the example shown, the lids 24, 26 are connectible to cover the wells 14, 16 through a threaded connection. For example, in FIGS. 2 and 3, each of the walls 18, 20 include threads 28, 30 on the external side of the walls 18, 20, which mate with internal threads 32, 34 (FIG. 3) on the first and second lids 24, 26.

Each of the first and second lids 24, 26 includes a respective surrounding wall 36, 38 and a closed top 40, 42. The first lid wall is generally orthogonal to the first lid top 40, while the second lid wall 38 is orthogonal to the second lid top 42. Along the internal surface of the lid walls 36, 38 are the lid threads 32, 34. In this manner, the first and second lids 24, 26 can be threadably mated with the well walls 18, 20 by way of the well threads 28, 30. The lid tops 40, 42 provide closure and cover over the wells 14, 16.

The first lid wall 36 and second lid wall 38 each has an outer surface 46, 48, and an opposite inner surface 50, 52. The inner surface 50, 52 engages and is against the respective well wall 18, 20, when the lids 24, 26 are operably and removeable connected to cover the wells 14, 16.

In preferred embodiments, the surrounding wall 36, 38 of each of the lids 24, 26 includes a plurality of circumferentially spaced notches 54, 56. In the embodiment shown, the lid notches 54, 56 are evenly spaced about the circumference of the outer surface 46, 48 of the lid walls 36, 38. In the embodiment shown, the notches 54, 56 extend substantially the entire axial length of the lid walls 36, 38. Of course, there can be variations, including having no notches whatsoever. Having the notches 54, 56, however, is preferred because it helps enhance the grip between a user and the lids 24, 26, and it helps the user manipulate the lids 24, 26 relative to the base 12. Alternating with the notches 54, 56 are circumferentially spaced projections, such that the outer surface 46, 48 of the lid walls 36, 38 include a plurality of alternating circumferentially spaced notches and projections.

In accordance with principles of this disclosure, the assembly 10 further includes at least a first removeable and replaceable gripping ring 60. In preferred assemblies, there will also be a second gripping ring 62, although both rings 60, 62 are not needed for the assembly 10.

The first and second removeable and replaceable gripping rings 60, 62 each includes a band 64, 66 which, when operably placed, is against and circumscribing the surrounding wall 36, 38 of the respective lid 24, 26. In the example embodiment shown, the first gripping ring 60 has first band 64 that is against and circumscribing the outer surface 46 of the first lid wall 36 of the first lid 24. The second gripping ring 62 has second band 66 against and circumscribing the outer surface 48 of the second lid wall 38 of the second lid 26. It should be understood that the first and second gripping rings 60, 62 are not specific to the first and second lids 24, 26; rather, the rings 60, 62 can be interchanged between the lids 24, 26.

While many embodiments can be made, in the example shown in the drawings, the band 64, 66 has a first end 68, 70 and an opposite second end 72, 74. The first end 68, 70 is a free end. An axial ring or face 76, 78 is generally perpendicular to the second end 72, 74. The axial face 76, 78 extends radially inwardly from the second end 72, 74 of the band 64, 66 and defines an opening 80, 82 therein. In use, when the rings 60, 62 are operably oriented on the lids 24, 26, the openings 80, 82 expose areas of visual indication 84, 86 on each of the lid tops 40, 42. These areas of visual indication 84, 86 will have some type of indication whether the lens is for the right eye or the left eye, and in the example shown, the letters R and L are used.

In the example shown, the lid tops 40, 42 each includes an axially projecting ridge 88, 90 forming a circle shape. In preferred embodiments, the edge of the axial face 76, 78 forming the openings 80, 82 is close to, or immediately adjacent to, or engage the ridges 88, 90.

The bands 64, 66 each includes an inner radial surface 92, 94 (FIG. 3), which is positioned against the outer surface 46, 48 of the lid walls 36, 38 of the lids 24, 26. The bands 64, 66 also include, opposite of the inner radial surface 92, 94 and outer radial surface 96, 98. When the first gripping ring 60 is oriented on the first lid 24, the inner radial surface 92 is against the outer surface 46 of the first lid wall 36 of the first lid 24. When the second gripping ring 62 is oriented over the second lid 26, the second inner radial surface 94 is against the outer surface 48 of the second lid wall 38 of the second lid 26.

In the embodiment shown, the outer radial surface 96, 98 of the rings 60, 62 each has a plurality of circumferentially spaced ribs 100, 102. In the embodiment shown, each of the ribs of the ribs 100, 102 extends at least partially between the respective first 68, 70 and second 72, 74 opposite ends of the bands 64, 66. In the preferred embodiment shown, the ribs extend axially completely between the respective first end 68, 70 and second end 72, 74. The ribs 100, 102 are preferably evenly circumferentially spaced about the outer radial surface 96, 98. Between the ribs 100, 102 are recesses 104, 106. As such, the first outer radial surface 96 includes a plurality of alternating circumferentially spaced ribs 100 and recesses 104. The outer radial surface 98 for the band 66 of the second gripping ring 62 includes a plurality of alternating ribs 102 and recesses 106 about the circumference of the outer radial surface 98. The ribs 100 extend axially between first end 68 and second end 72. The ribs 102 extend axially between the first end 70 and second end 74.

In preferred embodiments, the bands 64, 66 of the first and second gripping rings 60, 62 include a plurality of circumferentially spaced projections 108, 110 (FIG. 3) on the respective inner radial surface 92, 94. See FIG. 3. The projections 108, 110 extend at least partially between the respective first end 68, 70 and second end 72, 74 of the bands 64, 66. In preferred embodiments, the projections will extend substantially or fully the entire axial length along the inner radial surface 92, 94. Between the projections 108, 110 are recessed areas 112, 114. As such, the inner radial surface 92 includes a plurality of evenly and circumferentially spaced alternating projection 108 and recessed areas 112. Similarly, the inner radial surface 94 of the second band 66 includes evenly and circumferentially spaced alternating projections 110 and recessed areas 114.

As mentioned above, in preferred embodiments, the surrounding wall 36, 38 of the first and second lids 24, 26 preferably includes the plurality of circumferentially spaced notches 54, 56. When the lids 24, 26 have notches 54, 56, and when the gripping rings 60, 62 have projections 108, 110 along their inner radial surfaces 92, 94; and when the gripping rings 60, 62 are operably placed over the lids 24, 26, at least some of the projections 108, 110 are received within the respective notches 54, 56 of the lids 24, 26. That is, the projections 108 on the inner radial surface 92 of the first band 64 of the first gripping ring 60 are received within notches 54 of the first lid 24. Similarly, projections 110 on the inner radial surface 94 of the band 66 of the second gripping ring 62 are received within the notches 56 of the second lid 26. This engagement between projections 108, 110 and notches 54, 56 helps to enhance the grip between the rings 60, 62 and the lids 24, 26. This helps the user to more easily manipulate the lids 24, 26 relative to the well walls 18, 20 of the base 12.

The gripping rings 60, 62 may be made from a variety of materials. In preferred embodiments, the rings 60, 62 are made from a flexible elastomer material. A variety of materials could be used.

The gripping rings 60, 62 can help customize the appearance of the assembly 10. The rings 60, 62 can have a variety of patterns or colors. In one arrangement, the first gripping ring 60 is a visually distinct color that contrasts with the color of the first lid 24. For example, if the first lid 24 is white or a shade of white, the first gripping ring 60 can be of a color that is in high contrast to white including, for example, orange, yellow, blue, black, purple, etc. Similarly, the second gripping ring 62 can be a visually distinct color that contrasts with a color of the second lid 26. It may be preferably to have the first and second gripping rings 60, 62 also contrasting between each other to help the user further distinguish between the wells 14, 16 holding the right and left lenses.

It is contemplated that a kit can be provided, which will include the contact lens case having the base 12, first and second lids 24, 26, and at least a pair of gripping rings 60, 62. The kit could also have more than just a pair of gripping rings 60, 62 so that the user can periodically change the appearance of the overall assembly by removing one gripping ring and replacing it with another gripping ring of a different appearance such as a different color.

The gripping rings 60, 62 will generally be sized to snugly or frictionally fit over standard sized lids 24, 26 of standard contact lens cases. For example, the band 64, 66 will have an outer diameter of 1-1.5 inches and an axial length of at least ⅛^{th} of an inch. Typically, the band will have a length of no more than 0.5 inch. The opening 80, 92 in the axial face 76, 78 is preferably circular with a diameter of 0.5-⅞^{th} of an inch.

A method of using a contact lens case can employ the components described above. One example method includes providing a contact lens case having base 12 with at least a first well 14 sized to accommodate a contact lens and at least having first lid 24 removeably connected to cover the first well 14. The first lid has surrounding wall 36 and a closed top 40. The method will include removeably attaching first gripping ring 60 having band 64 against and around the surrounding wall 36 of the first lid 24.

The step of removeably attaching the gripping ring 60 includes orienting the free end 68 of the band 64 over the first lid 24 until the axial face 76 engages the closed top 40 of the first lid 24.

The stop of removeably attaching the gripping ring 60 may also include orienting at least some of the projections 108 on the inner radial surface 92 of the band 64 within the notches 54 of the first lid 24.

The method can also include removeably attaching the second gripping ring 62 with band 66 against and around the surrounding wall 38 of the second lid 26, wherein the second lid 26 is removeably connected to cover the second well 16 in the base 12 of the contact lens case.

The method may also further include, after the step of removeably attaching the gripping ring 60, grasping the band 64 and rotating the band 64 and the first lid 24 relative to the base 12 to either tighten the first lid 24 or loosen the first lid 24 relative to the base 12. Similarly, the band 66 of the second gripping ring can be grasped and rotated so that the second band 66 and the second lid 26 are rotated relative to the base 12 to either tighten the second lid 26 or loosen the second lid 26 relative to the base 12.

The above description is of examples and principles of the inventive. Many embodiments can be made using these principles.

We claim:

1. A contact lens case assembly comprising:
(a) a base having at least a first well sized to accommodate a contact lens;
(b) at least a first lid removably connected to selectively cover and expose the first well; the first lid having a surrounding wall and a closed top; and
(c) at least a first removable and replaceable gripping ring having a band against and circumscribing the surrounding wall of the first lid.

2. An assembly according to claim 1 wherein:
(a) the band of the first gripping ring has first and second opposite ends, the first end being a free end; and
(b) the first gripping ring further includes an axial face perpendicular to the second end; the axial face extending radially inwardly from the second end of the band and defining an opening therein.

3. An assembly according to claim 1 wherein:
(a) the band of the first gripping ring has:
(i) first and second opposite ends, the first end being a free end;
(ii) an inner radial surface positioned against the surrounding wall of the first lid and an opposite outer radial surface; and
(iii) a plurality of circumferentially spaced ribs on the outer radial surface, each rib extending at least partially between the first and second opposite ends.

4. An assembly according to claim 1 wherein:
(a) the band of the first gripping ring has:
(i) first and second opposite ends, the first end being a free end;
(ii) an inner radial surface positioned against the surrounding wall of the first lid and an opposite outer radial surface; and
(iii) a plurality of circumferentially spaced projections on the inner radial surface, each projection extending at least partially between the first and second opposite ends.

5. An assembly according to claim 4 wherein:
(a) the surrounding wall of the first lid includes a plurality of circumferentially spaced notches;
(i) at least some of the projections on the inner radial surface of the band of the first gripping ring being received within the notches.

6. An assembly according to claim 1 wherein:
(a) the first gripping ring comprises a flexible elastomer material.

7. An assembly according to claim 1 wherein:
(a) the first gripping ring comprises a visually distinct color contrasting with a color of the first lid.

8. An assembly according to claim 1 further comprising:
(a) a second well in the base sized to accommodate a contact lens;
(b) a second lid removably connected to selectively cover and expose the second well; the second lid having a surrounding wall and a closed top; and
(c) at least a second removable and replaceable gripping ring having a band against and circumscribing the surrounding wall of the second lid.

9. An assembly according to claim 8 wherein:
(a) the band of the second gripping ring has:
(i) first and second opposite ends, the first end being a free end;
(ii) an inner radial surface positioned against the surrounding wall of the second lid and an opposite outer radial surface;
(iii) a plurality of circumferentially spaced projections on the inner radial surface, each projection extending at least partially between the first and second opposite ends; and
(b) the surrounding wall of the second lid includes a plurality of circumferentially spaced notches;
(i) at least some of the projections on the inner radial surface of the band of the second gripping ring being received within the notches of the second lid.

10. A gripping ring for removable placement on a lid of a contact lens case; the gripping ring comprising:
(a) a cylindrical band having first and second opposite ends, the first end being a free end; an inner radial surface and an opposite outer radial surface;
(i) the band having an outer diameter of 1-1.5 inches;
(ii) the band having a length of at least ⅛^{th} inch;
(b) an axial face perpendicular to the second end; the axial face extending radially inwardly from the second end of the band and defining an opening therein; and
(c) a plurality of circumferentially spaced projections on the inner radial surface, each projection extending at least partially between the first and second opposite ends.

11. A gripping ring according to claim 10 further comprising:
(a) a plurality of circumferentially spaced ribs on the outer radial surface, each rib extending at least partially between the first and second opposite ends.

12. A gripping ring according to claim 10 wherein the ring is a flexible elastomer material.

13. A gripping ring according to claim 10 wherein:
(a) the opening in the axial face is circular having a diameter of 0.5-⅞^{th} inch; and
(b) the band has a length of no more than 0.5 inch.

14. A method of using a contact lens case; the method comprising:
(a) providing a contact lens case having a base with at least a first well sized to accommodate a contact lens and at least a first lid removably connected to cover the first well; the first lid having a surrounding wall and a closed top; and
(b) removably attaching a first gripping ring having a band against and around the surrounding wall of the first lid.

15. A method according to claim 14 wherein:
(a) the band of the first gripping ring has first and second opposite ends, the first end being a free end; the first gripping ring further includes an axial face perpendicular to the second end; the axial face extending radially inwardly from the second end of the band and defining an opening therein; and
(b) the step of removably attaching a first gripping ring includes orienting the free end of the band over the first lid until the axial face engages the closed top of the first lid.

16. A method according to claim 14 wherein:
(a) the band of the first gripping ring has:
(i) first and second opposite ends, the first end being a free end;
(ii) an inner radial surface positioned against the surrounding wall of the second lid and an opposite outer radial surface;
(iii) a plurality of circumferentially spaced projections on the inner radial surface;
(b) the surrounding wall of the first lid includes a plurality of circumferentially spaced notches; and
(c) the step of removably attaching a first gripping ring includes orienting at least some of the projections on the inner radial surface of the band within the notches of the first lid.

17. A method according to claim 14 further comprising:
(a) after the step of removably attaching a first gripping ring, removably attaching a second gripping ring having a band against and around a surrounding wall of a second lid, the second lid removably connected to cover a second well in the base of the contact lens case.

18. A method according to claim 14 further comprising:
(a) after the step of removably attaching a first gripping ring, grasping the band and rotating the band and first lid relative to the base to either tighten the first lid or loosen the first lid relative to the base.

19. A kit comprising:
(a) a contact lens case including a base having at least first and second wells each sized to accommodate a contact lens; and at least first and second lids removably connected to selectively cover and expose the first and second wells; and
(b) a plurality of elastomeric gripping rings, each of the gripping rings being constructed and arranged to removably attach against and around an individual one of the first lid and second lid.

20. A kit according to claim 19 wherein:
(a) each of the gripping rings has a visually distinct color contrasting with a color of the first lid and the second lid.
